(19) United States
(12) Patent Application Publication
(10) Pub. No.: US 2020/0209005 A1
(43) Pub. Date: Jul. 2, 2020

(54) SYSTEMS AND METHODS FOR LOADING OBJECT GEOMETRY DATA ON A VEHICLE

(71) Applicant: DiDi Research America, LLC, Mountain View, CA (US)

(72) Inventors: Tingbo Hou, Santa Clara, CA (US); Guomin Xiang, San Jose, CA (US)

(21) Appl. No.: 16/232,812

(22) Filed: Dec. 26, 2018

(51) Int. Cl. G01C 21/34; G01C 21/28

(52) U.S. Cl. CPC G01C 21/3492; G05D 1/0088; G01C 21/28

(57) ABSTRACT

A method and systems for loading object data on a moving vehicle. One system includes a data storage component configured to store object geometry data in a data structure such that a portion of the stored object geometry data representing an area around the vehicle may be retrieved, at least one processor having a memory component and configured to retrieve portions of the object geometry data from the data storage component and store the retrieved object geometry data in the memory component. The at least one processor also configured to obtain a location of the vehicle, determine data retrieval information based on the vehicle location, the data retrieval information defining a proximal portion of the object geometry data that is within a certain distance of the vehicle, and retrieve the proximal portion of the object geometry data from the data storage component and store it in the memory component.

### BACKGROUND

### Field

This disclosure generally relates to handling map data in vehicles, and, in particular, to dynamically loading map data into memory of a computer system on a vehicle for controlling the vehicle.

### Background

Current solutions for autonomous driving, providing driver-assist features, and/or ride-sharing services heavily rely on data maps, which may be referred to as high definition (HD) map data. This HD map data may have extremely high precision and include geographic and object data at the centimeter-size level to provide a vehicle and/or driver information that can be used to (along with real-time sensor data) generate precise control instructions on how to maneuver around the real-world space. The size of an HD map data can be extremely large due to its high resolution and detailed information. Continuously loading numerous HD map data for use by a vehicle may occur when driving over a distance where large amounts of HD map data are needed to accurately provide map information over a route. Due to the concerns of bandwidth and security with continuously transmitting large amounts of data over current wireless networks (e.g., 4G networks) to a moving system, it would be advantageous to have a secure system that can provide large HD map data without relying on transmission capabilities of wireless networks to receive the HD map data at the time they are immediately needed by the vehicle.

### SUMMARY

The systems, methods, and devices of the invention each have several aspects (features), no single aspect of which is solely responsible for its desirable attributes. Without limiting the scope of this invention as expressed by the claims which follow, some of the aspects are described below.

One innovation includes a method that may be implemented on a device (or system) on a vehicle, the method for loading data from a storage system capable of storing a large amount of data to a memory component (e.g., working memory or other quickly accessible memory) in communication with at least one processor. The device includes the at least one processor, the memory component and a data storage component coupled to the processor. In one embodiment, the method includes obtaining, by the at least one processor, a location of the vehicle, determining, by the at least one processor, data retrieval information based on the vehicle location, the data retrieval information identifying a proximal portion of stored object geometry data that is within a certain distance of the vehicle, retrieving, by the at least one processor, the proximal portion of the object geometry data from the data storage component, and storing, by the at least one processor, the proximal portion of the object geometry data in the memory component.

Embodiments of systems described herein may have one or more other aspects (features) in various embodiments of the system, a number of these aspects being noted here. However, various embodiments of such systems may have additional aspects or fewer aspects, and the aspects disclosed herein can be used together in an number of embodiments even if specifically not illustrated or described as being in a certain embodiment, as one of ordinary skill in the art will appreciate. In one aspect, the data storage component is configured to store the object geometry data in a data structure such that a portion of the stored object geometry data representing an area around the vehicle may be retrieved. In another aspect, the vehicle is an autonomous vehicle. In another aspect, the proximal portion of the object geometry data at least partially surrounds the vehicle. In another aspect the method further comprises obtaining, by the at least one processor, the speed and direction of the vehicle, and wherein determining the data retrieval information comprises determining the based at least in part on the speed and direction of the vehicle. In another aspect, the method further comprises determining a route of one or more roads for the vehicle to travel along from a location of the vehicle to a destination, obtaining road identification information indicative of a road the vehicle is on while the vehicle is traveling along the route, and determining the data retrieval information based on the vehicle location and the road identification information. In another aspect, the road identification information includes information on one or more roads that are along the route and that the vehicle is approaching.

In another aspect of the method, the method further comprises determining the distance the vehicle has traveled along the route, and wherein determining data retrieval information is based in part on the distance the vehicle has traveled along the route.

Another innovation includes a system implemented on a vehicle, for example in an autonomous vehicle. In an embodiment, the system includes a data storage component configured to store object geometry data in a data structure such that a portion of the stored object geometry data may be retrieved. The data storage component may be, for example, a magnetic or optical hard drive, or may include a one or more chips, that can store large amounts of data (e.g., gigabytes, terabytes, petabytes, or exabytes, or more) and allow retrieval of the stored information. The system also includes at least one processor having a memory component, wherein the at least one processor is configured to obtain a location of the vehicle, determine data retrieval information based on the vehicle location, the data retrieval information identifying a proximal portion of the object geometry data that is within a certain distance of the vehicle, and retrieve the proximal portion of the object geometry data from the data storage component and store it in the memory component.

Embodiments of systems described herein may have one or more other aspects (features) in various embodiments of the system, a number of these aspects being noted here. However, various embodiments of such systems may have additional aspects or fewer aspects, and the aspects disclosed herein can be used together in an number of embodiments even if specifically not illustrated or described as being in a certain embodiment, as one of ordinary skill in the art will appreciate. For example, in one aspect the proximal portion of the object geometry data at least partially surrounds the vehicle location. In another aspect, the proximal portion of the object geometry data is centered on the vehicle location. In another aspect, the proximal portion of the object geometry data extends farther in distance from the front of the vehicle at the vehicle location than from the back of the vehicle. In another aspect, the proximal portion of the object geometry data surrounds the vehicle location.

In various embodiments, a system may also include a global positioning system (GPS), and wherein the at least one processor is further configured to obtain the location of the vehicle from the GPS. In one aspect, the at least one processor is further configured to obtain the speed and direction of the vehicle, and determine the data retrieval information based at least in part on the speed and direction of the vehicle. In another aspect, the at least one processor is further configured to obtain road identification information indicative of a road the vehicle is on, and determine data retrieval information based on the vehicle location and the road identification information. In another aspect, the system further may include a navigation system configured to receive an input identifying a destination, determine a route of one or more roads for the vehicle to travel along from a location of the vehicle to the destination, determine the road identification information while the vehicle is traveling along the route, and communicate the road identification information to the at least one processor. In another aspect, the at least one processor is further configured to obtain a speed of the vehicle, and wherein the at least one processor is further configured to determine the data retrieval information based in part on the speed of the vehicle. In another aspect, the system further includes an odometer device configured to determine the distance the vehicle has traveled along the route, wherein the data retrieval information is based in part on the distance the vehicle has traveled along the route. In another aspect, the road identification information includes information on roads that are along the route that the vehicle is approaching.

Another innovation includes a method of loading information (e.g., HD map data) for a vehicle which may be implemented on a device of a moving vehicle, the device having at least one processor and a storage component coupled to the processor. In one example, the method includes obtaining, by the at least one processor, a geographic location of the device, obtaining a boundary corresponding to a contiguous geographical boundary area around the geographic location of the device, loading map data comprising a plurality of map data tiles from the storage component to a memory of the device, each of the plurality of map data tiles including a portion of the geographical boundary area, the geographical boundary area corresponding to a portion of the loaded map data, wherein the plurality of map data tiles includes a center tile having a point corresponding to the geographic location of the device and surrounding map data tiles, and wherein the boundary is centered on the center tile and dimensioned such that the geographical boundary area intersects the surrounding map data tiles. The method may further includes, while the vehicle is in motion, obtaining, by the at least one processor, an updated geographic location of the device, determining the position of the updated geographic location relative to the boundary area, and in response to determining the updated geographic location is outside of the boundary area, obtaining an updated boundary corresponding to an updated geographic area centered on the updated geographic location and loading map data from the storage component to the memory of the device, such that the resulting loaded map data includes a center tile having a point corresponding to the updated geographic location of the device, and map data tiles surrounding the center tile that intersect the geographical boundary area.

The methods described herein may have one or more other aspects (features) in various embodiments of the method, a number of these aspects being noted here. However, various embodiments of such methods may have additional aspects or fewer aspects, and the aspects disclosed herein can be used together in an number of embodiments even if specifically not illustrated or described as being in a certain embodiment, as one of ordinary skill in the art will appreciate. For example, in one aspect the surrounding map data tiles are adjacent to the center tile. In another aspect the map data tiles comprise elevation information. In another aspect the map data tiles comprise intensity information. In another aspect the geographical boundary area corresponds to an area that includes the center tile and at least a portion of the map data tiles adjacent to the center tile. In another aspect the boundary is rectangular-shaped. In another aspect, each map data tile comprises a width dimension and a length dimension, and the boundary comprises a width dimension and a length dimension, the boundary width dimension is between one and three times the width dimension of each map data tile, and the boundary length dimension is between one and three times the length dimension of each map data tile.

In another aspect of a method, the loaded map data includes nine map data tiles. In another aspect, each of the nine map data tiles has equal dimensions. In another aspect, the nine map data tiles include a center map data tile and eight surrounding map data tiles. In another aspect, the map data tiles include a center map data tile and more than eight surrounding map data tiles. In another aspect, the vehicle is an autonomous vehicle. In another aspect, the boundary may be non-rectangular. For example, the boundary may be more expansive (i.e., encompassing more area) in an area that represents the direction the vehicle is moving in, will be moving in next, or is expected to move in. In another aspect, the size of the boundary and the updated boundary are pre-determined. In another aspect, obtaining the updated boundary comprises dynamically determining the updated boundary. In another aspect, dynamically determining the updated boundary comprises obtaining a velocity of the moving vehicle and determining a dimension of the boundary based on the velocity. In another aspect, dynamically determining the updated boundary comprises obtaining a velocity of the moving vehicle and determining a shape of the boundary based on the velocity. Some of the methods may further include determining a motion direction representing the direction the vehicle is moving, wherein the boundary extends farther from the updated geographical location of the device in the direction of the motion direction than the boundary extends in other directions. Various storage devices suitable for storing and transferring large HD maps may be used, and in some embodiments the storage device may include an optical drive or a magnetic hard drive. Other types of hard drives may also be used. In some embodiments, the storage device may include non-moving storage devices (e.g., RAM or DRAM).

In another aspect of a method each map data tile is representative of an area that has a width dimension of less than 1000 meters and/or a length dimension of less than 1000 meters. In another aspect, each map data tile is representative of an area that has a width dimension of less than 500 meters and/or a length dimension of less than 500 meters. Other dimensions for the map data tiles are also contemplated, including that each map data tile is representative of an area that has a width dimension of less than 250 meters and/or a length dimension of less than 250 meters, each map data tile is representative of an area that has a width dimension of about 200 meters and/or a length dimension of about 200 meters, or each map data tile is representative of an area that has a width dimension of less than 100 meters and a length dimension of less than 100 meters.

In another aspect, the boundary is dimensioned such that in response to determining the updated geographic location is outside of the boundary area, loading map data based on the updated geographic location comprises loading three map data tiles. In another aspect, the boundary is dimensioned such that in response to determining the updated geographic location is outside of the boundary area, loading map data based on the updated geographic location comprises loading five map data tiles. In another aspect, obtaining a geographic location of the device comprises receiving, by the at least one processor, information from a global positioning system (GPS). In another aspect, obtaining a geographic location of the device comprises receiving geographic location information from at least one transmitter at a fixed location. In another aspect, obtaining a geographical location of the device comprises sensing at least one fixed location indicator using a sensing system on the vehicle, and determining a geographical location based on the sensed at least one fixed location indicator.

Another innovation includes a system, comprising a storage system configured to store map data comprising a plurality of map data tiles, at least one processor coupled to a memory component including a set of instructions and coupled to the storage system, when executing the set of instructions, the at least one processor is configured to cause the system to obtain a location of the device, obtain a boundary corresponding to a contiguous geographical boundary area around the geographic location of the device, load map data from the storage component to the memory of the device, the map data comprising a plurality of map data tiles, each of the plurality of map data tiles including a portion of the geographical boundary area and the geographical boundary area corresponding to a portion of the loaded map data, where the plurality of map data tiles includes a center tile having a point corresponding to the geographic location of the device and surrounding map data tiles, and where the boundary is centered on the center tile and dimensioned such that the geographical boundary area intersects the surrounding map data tiles. The system is further configured to obtain an updated geographic location of the device (e.g., when the device is in motion on a vehicle), determine the position of the updated geographic location relative to the boundary area, and in response to determining the updated geographic location is outside of the boundary area, obtain an updated boundary centered on the updated geographic location and load map data from the storage component to the memory of the device based on the updated boundary. The system can further include the vehicle.

Aspects disclosed above relating to the method can also be implemented on the system. For example, the memory component can include instructions to configure the at least one processor perform the actions related to loading map data described above for the method.

Another innovation includes a non-transitory computer readable medium storing instructions, the instructions, when executed by a computing device, causing the computing device to obtain a geographic location of the device, obtain a boundary corresponding to a contiguous geographical boundary area around the geographic location of the device, load map data from the storage component to the memory of the device, the map data comprising a plurality of map data tiles, each of the plurality of map data tiles including a portion of the geographical boundary area and the geographical boundary area corresponding to a portion of the loaded map data, wherein the plurality of map data tiles includes a center tile having a point corresponding to the geographic location of the device and surrounding map data tiles, and wherein the boundary is centered on the center tile and dimensioned such that the geographical boundary area intersects the surrounding map data tiles, and while the vehicle is in motion: obtain an updated geographic location of the device, determine the position of the updated geographic location relative to the boundary area, and in response to determining the updated geographic location is outside of the boundary area, obtain an updated boundary centered on the updated geographic location and load map data from the storage component to the memory of the device based on the updated boundary.

### BRIEF DESCRIPTION OF THE DRAWINGS

The features and advantages of the devices described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. In some instances, the drawings may not be drawn to scale.

FIG. 1A illustrates a block diagram of a networked vehicle environment in which one or more vehicles and/or one or more user devices interact with a server via a network, according to one embodiment.

FIG. 1B illustrates a block diagram showing the vehicle of FIG. 1A in communication with one or more other vehicles and/or the server of FIG. 1A, according to one embodiment.

FIG. 2 is a schematic illustrating a vehicle moving along a road and examples of components that the vehicle may use to determine its geographical location information.

FIG. 3 is a schematic illustrating an example of map data that may be represented by a plurality of map data tile.

FIG. 4 is a schematic illustrating an example of HD map data that may be loaded into memory based on a vehicle initial (or first) geographic location, for example, by loading the HD map data from a plurality of data tiles or by a determined distance around the vehicle.

FIG. 5 is a schematic illustrating an example of HD map data that may be loaded into memory based on a vehicle updated (or second) geographic location, for example, by loading the data from a plurality of data tiles or by a determined distance around the vehicle.

FIGS. 6A-6D illustrate examples of portions of the stored object geometry data that may be retrieved from a large geometry data storage component and stored into a memory component (e.g., working memory) for a vehicle. Object geometry data may be referred to herein (for brevity) as “object data” or “geometry data.” The geometry data retrieved from the storage component represents a “proximal portion” (e.g., proximal to a vehicle, a vehicle location, or another reference point used to retrieve geometry data) of the stored geometry data. Each of FIGS. 6A-6D illustrate an example of a proximal portion of geometry data being enclosed by a representative retrieval area boundary, according to various embodiments. Specifically, FIG. 6A illustrates a circular-shaped retrieval boundary with centered on the vehicle. FIG. 6B illustrates a elliptical-shaped retrieval boundary centered on the vehicle. FIG. 6C illustrates a retrieval boundary that is larger in front of the vehicle than on the sides of the vehicle and behind the vehicle. FIG. 6D illustrates an elliptical-shaped retrieval boundary offset relative to the vehicle such that it extends further in front of the vehicle than in the back of the vehicle.

FIG. 7A is a schematic illustrating a vehicle traveling on a road along a route and other roads along the route the intersect the road the vehicles traveling along.

FIG. 7B is a schematic illustrating a vehicle traveling along a route and geometry data being retrieved by the vehicle, according to an embodiment.

FIG. 7C is a schematic illustrating a vehicle traveling along a another route and geometry data being retrieved by the vehicle, according to an embodiment.

FIG. 8 is a schematic of an example of a computer system that can be on a vehicle and that can be used to perform the map data loading described herein.

FIG. 9 is an illustration of a flow diagram representing an example of a method of loading object geometry data from a storage component, having a large storage capacity, to a memory component that is coupled to at least one processor.

### DETAILED DESCRIPTION OF CERTAIN INVENTIVE ASPECTS

The following detailed description is directed to certain aspects and examples of the invention. However, the invention can be embodied in a multitude of different ways. It should be apparent that the aspects herein may be embodied in a wide variety of forms and that any specific structure, function, or both being disclosed herein is merely representative of one or more embodiments of the invention. An aspect disclosed herein may be implemented independently of any other aspects and that two or more of these aspects may be combined in various ways. For example, different embodiments of methods of loading map data from a map data storage system configured to store large quantities of data (e.g., terabytes or more) into a “working” memory of a computer system on a vehicle as it is moving along a route may be implemented using a number of the aspects/features disclosed herein. In addition, such a method may be implemented or such a system may be practiced using other processes, steps, structure, functionality, or structure in addition to, or other than one or more of the aspects set forth herein.

HD maps may contain many type of information, ranging from raw data (e.g., images captured at a certain location and at a certain orientation with respect the location) to representations of features or objects (e.g., information representing roads, signs, man-made objects near a road, natural objects near a road, etc.). Such data and features may represent information that was previously collected by another vehicle traveling along a road, or determined to be near a road (e.g., elevation data). Generally, as used herein, “near a road” or “proximal to a road” or “proximal portion” or the like refers to information that may be sensed by one or more sensors of a sensor system disposed on a vehicle, or information that a vehicle may use for positioning the vehicle or controlling the vehicle.

Various embodiments of HD maps may include different information, that may be provided by various data information systems on one or more storage components. For example, information in an HD map, or a portion of an HD map (e.g., a map data tile), may include information that represents one or more of elevation, intensity, natural features (geographic features), roads, signs, buildings houses, walkways, landscape, and other man-made objects or objects placed in a location by man. In some embodiments, HD maps include elevation information intensity information. In some embodiments, information representing objects, for example man-made objects, are stored in a separate data storage arrangement from elevation and/or intensity information. For example, in a database which can be queried as needed for the objects around a vehicle is a vehicle moves along a route. Such queries may be based on a predetermined distance around a vehicle, that is, such that all the objects within a certain distance are returned based on such the query. In another example, such queries may be based on a distance around the vehicle that changes based on one or more factors, for example, the vehicle's speed, location (e.g., city or country road), or direction of travel.

To be effective for use by a vehicle, HD maps may include information at a centimeter-scale resolution. In an illustrative embodiment, in example of raw data structured on a 10 cm×10 cm grid, the resolution may be determined by the upper bound of errors a vehicle can tolerate. For each cell on the grid, three bytes may be used: one for intensity information, and two bytes for elevation information. Therefore, for one square meter, 300 bytes in memory (10*10*3) are used. For an area of 10 km by 10 km, storage of the data may require 30 GB of memory (e.g., 10 k *10 k *300). If the stored data is compressed, less memory may be required. However, any decompression of data is being retrieved from a data storage component requires at least some additional overhead associated with the decompression processes, and thus may increase overhead for retrieving the data. Storage of the HD map data is one issue. Communicating the HD map data from a storage location to the vehicle is a another issue. Such communication must be reliable, efficient, and secure to ensure the required HD map data is available when needed.

As a vehicle moves from point a first point to a second point, a navigation system may provide the route the vehicle should use, for example, indicating the particular highways and streets for the vehicle to use. For second-to-second control of the vehicle, only the data around the vehicle may need to be loaded. When the vehicle is moving, we can load new data into memory, and remove old data from it. In one embodiment to implement a method of loading new HD maps into memory and removing old HD maps from memory, we a grid of information that the vehicle is moving through can be portrayed as tiles of information. For example, each tile may have a data resolution of 2000 by 2000, which corresponds to 200 m by 200 m in real world.

One example of choosing the dimensions for map data tiles may be based on tile loading frequency and tile size. We don't want to load tiles too frequently. The I/O for reading files from disk is expensive. This indicates that tiles cannot be too small. In urban areas, a vehicle may move with speed from 10 m/s to 20 m/s. Therefore, it takes 10 to 20 seconds for a vehicle to pass through one tile. This results in a frequency of 0.05 to 0.1 Hz, which is affordable. The size of the tile should not be too large because that will take more memory. Although computers on a vehicle may be usually very powerful, the computing resources may actually be very limited because of all the computing needs that take place on the vehicle. In an example where the memory consumption of HD maps is desired to be about 100 MB or less, a tile takes 2 k *2 k *3 B=12 MB memory. So nine tiles will take 108 MB memory. We want the full tile loading to be finished in 100 ms, faster if possible. Tile dimensions should be compatible with loading time at different scenarios. Larger tile size results in longer loading time, which can result in a tile not being available before it is needed to be accessed. On the contrary, smaller tile size results in higher loading frequency, where a similar availability issue may happen as the vehicle quickly moves across one tile of information and needs the next tiles. Tiles may be compressed files. For a tile size of 2000 by 2000, it takes about 10 ms to fully load a tile, including reading and decompressing. So, loading a full nine-tile pack may takes less 100 ms, which can be done by one thread before the vehicle goes to unloaded area. To account for the above-described issues, in one embodiment, 2000 by 2000 is a tile size that satisfies resource constrictions and optimizes loading frequency.

Certain embodiments described herein include using map data that is configured in arrangement of tiles. As needed, one or more tiles a loaded from a storage component into the memory of a device controlling the time is vehicle. For example, at any time, there are nine tiles loaded in memory representing a certain bounded area around the vehicle. To seamlessly serve the HD map data, tiles that the vehicle may goes to may be pre-loaded in a background thread. The tile loading is completely hidden for clients. For example, a boundary defining an area (or region) with a size of 4000 by 4000 may be placed around a center tile. When the vehicle moves within the bounded area, there is no change to tile loading. When the vehicle moves out of the bounded area, new tiles will be loaded to make a new nine-tile arrangement around the center tile.

A method for loading map data may be implemented on a computing device of a vehicle. The method can include for example obtaining the geographic position of the vehicle, using for example GPS, and inertia navigation system, position indicators fixed along a road that are sensed by one or more sensors of the vehicle, and/or receiving transmissions (e.g., radio or optical) from transmitters positioned in locations with the vehicles can receive their signals. A boundary corresponding to a geographical boundary area around the position of the vehicle may be obtained (e.g., calculated). Then, the method may load map data that includes a plurality of map data tiles from a storage component to a memory of the device. Each of the plurality of map data tiles include a portion of the due geographical boundary area around the vehicle, the geographical boundary area corresponding to a portion of the loaded map data. That is, the total loaded map data covers the geographical boundary area and extends beyond the geographical boundary area, based on the tile size. The plurality of map data tiles may include a center tile having a point corresponding to the geographic location of the device. The plurality of map tiles may also include surrounding mandated tiles that are arranged around the center tile (and around the location of the vehicle). The boundary is centered on the center tile and dimension such the geographical boundary area intersects the surrounding map data tiles. For example, the loaded map data may include nine tiles arranged in a rectangle, the vehicle's location corresponding to a point in the center tile.

While the vehicle is in motion an updated geographic location of the device is obtained (e.g., using GPS, roadside location indicia, an inertia location system, etc.) and the systems determines the position of the vehicle at the updated geographical location relative to the boundary area. In response to determining the updated location of the vehicle is outside of the boundary area, an updated boundary is determined. The updated boundary corresponds to an updated area centered on the updated location of the vehicle. Map data in the form of map data tiles may be loaded from the storage component to the memory of the device such that the resulting loaded map data includes a center tile having a point corresponding to the updated location of device (vehicle), and map data tiles surrounding the center tile that intersect the boundary area. In other words, when the vehicle's location is determined to have exceeded the boundary area as defined by the most recent determined boundary, additional map data tiles are loaded.

Other embodiments describe map data that is stored a database. In such embodiments, the map data may include information relating the data to a location. For example, information relating a man-made or a natural object to a geographic position (e.g., a latitude and longitude, or indicia corresponding to a geographical location) and/or to a road. For example, to provide a computer system on a vehicle with information it may use for positioning or controlling the vehicle or assisting in positioning or controlling the vehicle, the location of the vehicle can be tracked and map data that relates to an area near or around the vehicle may be loaded to the memory of the computer system from another data storage component. In some embodiments, the location of the vehicle may be determined using information from a GPS system, a navigation system (e.g., that contains information about the route the vehicle is traveling), an inertia guidance system, location indicia along the road, optical or electromagnetic translation systems, or the like.

In some embodiments, the computer system tracks the road the vehicle is traveling along and the distance the vehicle has traveled on the road. Objects in the map data are each associated with at least one road (and can be associated with more than one road depending on their location, for example, if they're located at the intersection of two or more roads). In such embodiments, the objects in the map data that are retrieved for a vehicle at any particular time (or location) are the objects that are associated with the road that the vehicle is currently on and that are within a certain range and/or position of the vehicle. When the vehicle moves to new road, objects associate with the new road and within a certain range and/or position of the vehicle are returned. In a situation where two or more roads overlap or intersect, and an ambiguity may occur relating to which road the vehicle is actually on. In one embodiment, to resolve any such ambiguity, the computer system of the vehicle may use knowledge of a planned route of the vehicle to determine on which of the overlapped or intersected roads the vehicle is located, and then use this determined location to retrieve map data, proximal to the determined location, from the storage component. For example, information from a navigation system that includes every road along a route that the vehicle will use can be used alone or in conjunction with other information (e.g., from sensor systems) to determine which road the vehicle is most likely on, and the appropriate map data corresponding to the environment around the vehicle on the determined road can be loaded for use to position and control the vehicle.

In various embodiments, and in various situations, the amount of data retrieved around the vehicle may vary, and be controlled by one or more parameters including a maximum distance and/or minimum distance from the vehicle, orientation relative to the road, orientation relative to the vehicle, in an area centered or off-centered from the vehicle, and/or in a symmetric or asymmetrically shaped area, etc. In some embodiments, information relating to the vehicle itself may be used to control the map data that is ordered. For example, the speed of the vehicle may be used to determine how much map data in front of the vehicle, or around the vehicle, is retrieved. In some embodiments, as the speed of the vehicle increases, the area of map data ordered correspondingly increases. In one example of such an embodiment, as a speed of the vehicle increases, the amount of map data ordered in an area in front of the vehicle also increases. In such embodiments, the amount of map data ordered behind the vehicle and/or on the sides of the vehicle may be decreased. In some embodiments, the computer system on the vehicle uses knowledge of the location of the vehicle and/or the road the vehicles on to increase or decrease the amount of data that is retrieved for particular location. In some embodiments, the methods use tree structures to accelerate the retrieval of map data from a database on a storage component

### Illustrative Embodiment

Embodiments of system and methods for loading map data are described below in reference to the figures. It will be appreciated by those of ordinary skill in the art that various modifications and changes may be made without departing from the scope of the described technology. Such modifications and changes are intended to fall within the scope of the embodiments. It will also be appreciated by those of ordinary skill in the art that parts included in one embodiment are interchangeable with other embodiments—one or more parts from a depicted embodiment can be included with other depicted embodiments in any combination. For example, any of the various components described herein and/or depicted in the figures may be combined, interchanged or excluded from other embodiments.

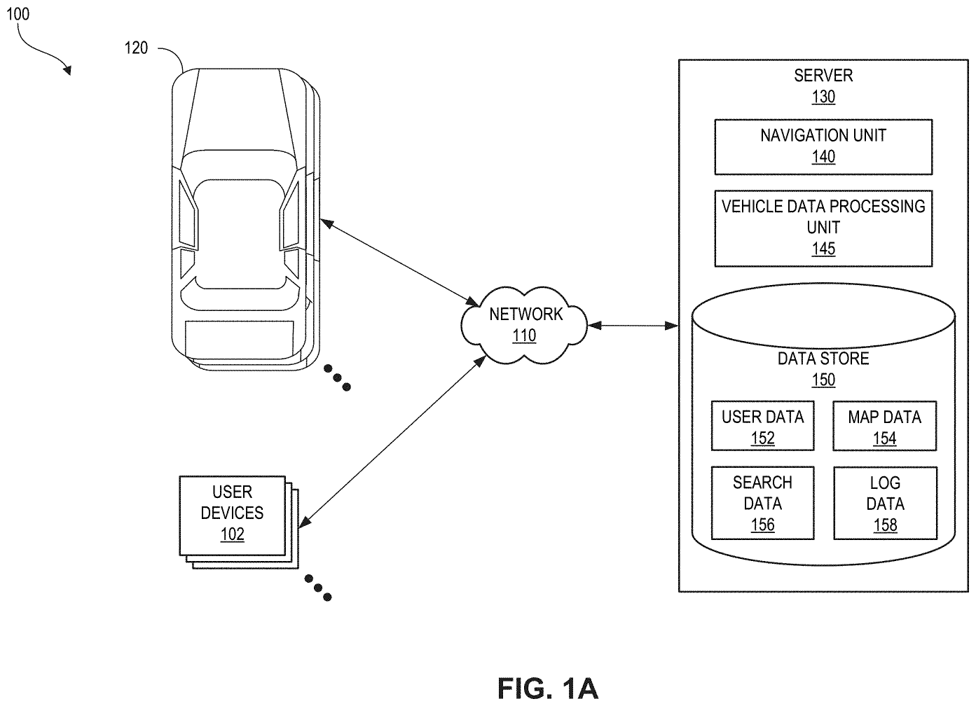

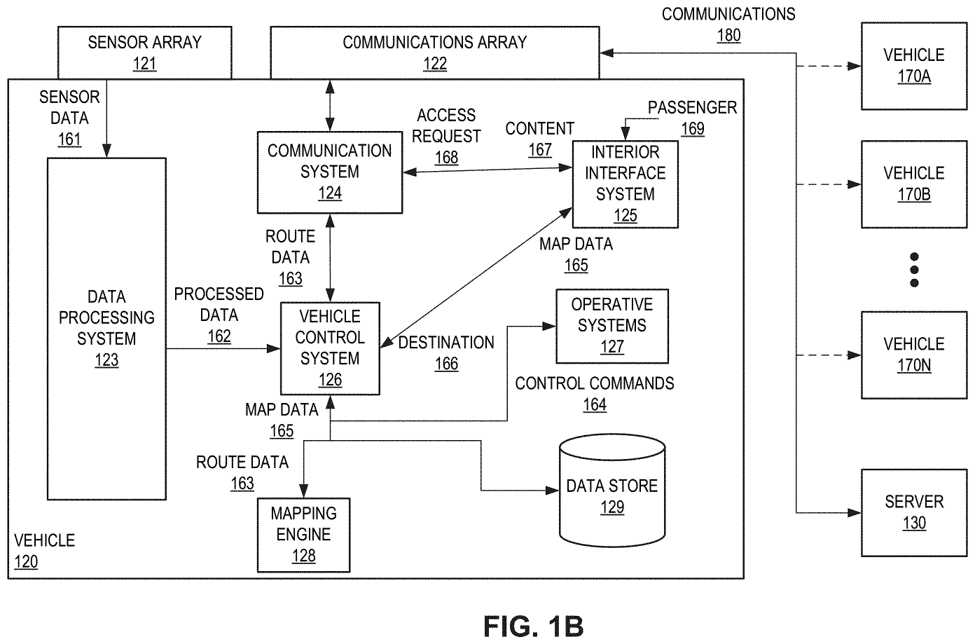

FIG. 1A illustrates a block diagram of a networked vehicle environment 100 in which one or more vehicles 120 and/or one or more user devices 102 interact with a server 130 via a network 110, according to one embodiment. For example, the vehicles 120 may be equipped to provide ride-sharing and/or other location-based services, to assist drivers in controlling vehicle operation (e.g., via various driver-assist features, such as adaptive and/or regular cruise control, adaptive headlight control, anti-lock braking, automatic parking, night vision, blind spot monitor, collision avoidance, crosswind stabilization, driver drowsiness detection, driver monitoring system, emergency driver assistant, intersection assistant, hill descent control, intelligent speed adaptation, lane centering, lane departure warning, forward, rear, and/or side parking sensors, pedestrian detection, rain sensor, surround view system, tire pressure monitor, traffic sign recognition, turning assistant, wrong-way driving warning, traffic condition alerts, etc.), and/or to fully control vehicle operation. Thus, the vehicles 120 can be regular gasoline, natural gas, biofuel, electric, hydrogen, etc. vehicles configured to offer ride-sharing and/or other location-based services, vehicles that provide driver-assist functionality (e.g., one or more of the driver-assist features described herein), and/or automated or autonomous vehicles (AVs). The vehicles 120 can be automobiles, trucks, vans, buses, motorcycles, scooters, bicycles, and/or any other motorized vehicle.

The server 130 can communicate with the vehicles 120 to obtain vehicle data, such as route data, sensor data, perception data, vehicle 120 control data, vehicle 120 component fault and/or failure data, etc. The server 130 can process and store the vehicle data for use in other operations performed by the server 130 and/or another computing system (not shown). Such operations can include running diagnostic models to identify vehicle 120 operational issues (e.g., the cause of vehicle 120 navigational errors, unusual sensor readings, an object not being identified, vehicle 120 component failure, etc.); running models to simulate vehicle 120 performance given a set of variables; identifying objects that cannot be identified by a vehicle 120, generating control instructions that, when executed by a vehicle 120, cause the vehicle 120 to drive and/or maneuver in a certain manner along a specified path; and/or the like.

The server 130 can also transmit data to the vehicles 120. For example, the server 130 can transmit map data, firmware and/or software updates, vehicle 120 control instructions, an identification of an object that could not otherwise be identified by a vehicle 120, passenger pickup information, traffic data, and/or the like.

In addition to communicating with one or more vehicles 120, the server 130 can communicate with one or more user devices 102. In particular, the server 130 can provide a network service to enable a user to request, via an application running on a user device 102, location-based services (e.g., transportation services, such as ride-sharing services). For example, the user devices 102 can correspond to a computing device, such as a smart phone, tablet, laptop, smart watch, or any other device that can communicate over the network 110 with the server 130. In the embodiment, a user device 102 executes an application, such as a mobile application, that the user operating the user device 102 can use to interact with the server 130. For example, the user device 102 can communicate with the server 130 to provide location data and/or queries to the server 130, to receive map-related data and/or directions from the server 130, and/or the like.

The server 130 can process requests and/or other data received from user devices 102 to identify service providers (e.g., vehicle 120 drivers) to provide the requested services for the users. In addition, the server 130 can receive data—such as user trip pickup or destination data, user location query data, etc.—based on which the server 130 identifies a region, an address, and/or other location associated with the various users. The server 130 can then use the identified location to provide services providers and/or users with directions to a determined pickup location.

The application running on the user device 102 may be created and/or made available by the same entity responsible for the server 130. Alternatively, the application running on the user device 102 can be a third-party application that includes features (e.g., an application programming interface or software development kit) that enables communications with the server 130.

A single server 130 is illustrated in FIG. lA for simplicity and ease of explanation. It is appreciated, however, that the server 130 may be a single computing device, or may include multiple distinct computing devices logically or physically grouped together to collectively operate as a server system. The components of the server 130 can be implemented in application-specific hardware (e.g., a server computing device with one or more ASICs) such that no software is necessary, or as a combination of hardware and software. In addition, the modules and components of the server 130 can be combined on one server computing device or separated individually or into groups on several server computing devices. In some embodiments, the server 130 may include additional or fewer components than illustrated in FIG. 1A.

The network 110 includes any wired network, wireless network, or combination thereof. For example, the network 110 may be a personal area network, local area network, wide area network, over-the-air broadcast network (e.g., for radio or television), cable network, satellite network, cellular telephone network, or combination thereof. As a further example, the network 110 may be a publicly accessible network of linked networks, possibly operated by various distinct parties, such as the Internet. In some embodiments, the network 110 may be a private or semi-private network, such as a corporate or university intranet. The network 110 may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The server 130 can include a navigation unit 140, a vehicle data processing unit 145, and a data store 150. The navigation unit 140 can assist with location-based services. For example, the navigation unit 140 can facilitate the transportation of a user (also referred to herein as a “rider”) and/or an object (e.g., food, packages, etc.) by another user (also referred to herein as a “driver”) from a first location (also referred to herein as a “pickup location”) to a second location (also referred to herein as a “destination location”). The navigation unit 140 may facilitate user and/or object transportation by providing map and/or navigation instructions to an application running on a user device 102 of a rider, to an application running on a user device 102 of a driver, and/or to a navigational system running on a vehicle 120.

As an example, the navigation unit 140 can include a matching service (not shown) that pairs a rider requesting a trip from a pickup location to a destination location with a driver that can complete the trip. The matching service may interact with an application running on the user device 102 of the rider and/or an application running on the user device 102 of the driver to establish the trip for the rider and/or to process payment from the rider to the driver.

The navigation unit 140 can also communicate with the application running on the user device 102 of the driver during the trip to obtain trip location information from the user device 102 (e.g., via a global position system (GPS) component coupled to and/or embedded within the user device 102) and provide navigation directions to the application that aid the driver in traveling from the current location of the driver to the destination location. The navigation unit 140 can also direct the driver to various geographic locations or points of interest, regardless of whether the driver is carrying a rider.

The vehicle data processing unit 145 can be configured to support vehicle 120 driver-assist features and/or to support autonomous driving. For example, the vehicle data processing unit 145 can generate and/or transmit to a vehicle 120 map data, run diagnostic models to identify vehicle 120 operational issues, run models to simulate vehicle 120 performance given a set of variables, use vehicle data provided by a vehicle 120 to identify an object and transmit an identification of the object to the vehicle 120, generate and/or transmit to a vehicle 120 vehicle 120 control instructions, and/or the like.

The data store 150 can store various types of data used by the navigation unit 140, the vehicle data processing unit 145, the user devices 102, and/or the vehicles 120. For example, the data store 150 can store user data 152, map data 154, search data 156, and log data 158.

The user data 152 may include information on some or all of the users registered with a location-based service, such as drivers and riders. The information may include, for example, usernames, passwords, names, addresses, billing information, data associated with prior trips taken or serviced by a user, user rating information, user loyalty program information, and/or the like.

The map data 154 may include high definition (HD) maps generated from sensors (e.g., light detection and ranging (LiDAR) sensors, radio detection and ranging (RADAR) sensors, infrared cameras, visible light cameras, stereo cameras, an inertial measurement unit (IMU), etc.), satellite imagery, optical character recognition (OCR) performed on captured street images (e.g., to identify names of streets, to identify street sign text, to identify names of points of interest, etc.), etc.; information used to calculate routes; information used to render 2D and/or 3D graphical maps; and/or the like. For example, the map data 154 can include elements like the layout of streets and intersections, bridges (e.g., including information on the height and/or width of bridges over streets), off-ramps, buildings, parking structure entrances and exits (e.g., including information on the height and/or width of the vehicle entrances and/or exits), the placement of street signs and stop lights, emergency turnoffs, points of interest (e.g., parks, restaurants, fuel stations, attractions, landmarks, etc., and associated names), road markings (e.g., centerline markings dividing lanes of opposing traffic, lane markings, stop lines, left turn guide lines, right turn guide lines, crosswalks, bus lane markings, bike lane markings, island marking, pavement text, highway exist and entrance markings, etc.), curbs, rail lines, waterways, turning radiuses and/or angles of left and right turns, the distance and dimensions of road features, the placement of barriers between two-way traffic, and/or the like, along with the elements' associated geographical locations (e.g., geographical coordinates). The map data 154 can also include reference data, such as real-time and/or historical traffic information, current and/or predicted weather conditions, road work information, information regarding laws and regulations (e.g., speed limits, whether right turns on red lights are permitted or prohibited, whether U-turns are permitted or prohibited, permitted direction of travel, and/or the like), news events, and/or the like.

While the map data 154 is illustrated as being stored in the data store 150 of the server 130, this is not meant to be limiting. For example, the server 130 can transmit the map data 154 to a vehicle 120 for storage therein (e.g., in the data store 129, described below).

The search data 156 can include searches entered by various users in the past. For example, the search data 156 can include textual searches for pickup and/or destination locations. The searches can be for specific addresses, geographical locations, names associated with a geographical location (e.g., name of a park, restaurant, fuel station, attraction, landmark, etc.), etc.

The log data 158 can include vehicle data provided by one or more vehicles 120. For example, the vehicle data can include route data, sensor data, perception data, vehicle 120 control data, vehicle 120 component fault and/or failure data, etc.

FIG. 1B illustrates a block diagram showing the vehicle 120 of FIG. 1A in communication with one or more other vehicles 170A-N and/or the server 130 of FIG. 1A, according to one embodiment. As illustrated in FIG. 1B, the vehicle 120 can include various components and/or data stores. For example, the vehicle 120 can include a sensor array 121, a communications array 122, a data processing system 123, a communication system 124, an interior interface system 125, a vehicle control system 126, operative systems 127, a mapping engine 128, and/or a data store 129.

Communications 180 may be transmitted and/or received between the vehicle 120, one or more vehicles 170A-N, and/or the server 130. The server 130 can transmit and/or receive data from the vehicle 120 as described above with respect to FIG. 1A. For example, the server 130 can transmit vehicle control instructions or commands (e.g., as communications 180) to the vehicle 120. The vehicle control instructions can be received by the communications array 122 (e.g., an array of one or more antennas configured to transmit and/or receive wireless signals), which is operated by the communication system 124 (e.g., a transceiver). The communication system 124 can transmit the vehicle control instructions to the vehicle control system 126, which can operate the acceleration, steering, braking, lights, signals, and other operative systems 127 of the vehicle 120 in order to drive and/or maneuver the vehicle 120 and/or assist a driver in driving and/or maneuvering the vehicle 120 through road traffic to destination locations specified by the vehicle control instructions.

As an example, the vehicle control instructions can include route data 163, which can be processed by the vehicle control system 126 to maneuver the vehicle 120 and/or assist a driver in maneuvering the vehicle 120 along a given route (e.g., an optimized route calculated by the server 130 and/or the mapping engine 128) to the specified destination location. In processing the route data 163, the vehicle control system 126 can generate control commands 164 for execution by the operative systems 127 (e.g., acceleration, steering, braking, maneuvering, reversing, etc.) to cause the vehicle 120 to travel along the route to the destination location and/or to assist a driver in maneuvering the vehicle 120 along the route to the destination location.

A destination location 166 may be specified by the server 130 based on user requests (e.g., pickup requests, delivery requests, etc.) transmitted from applications running on user devices 102. Alternatively or in addition, a passenger and/or driver of the vehicle 120 can provide user input(s) 169 through an interior interface system 125 (e.g., a vehicle navigation system) to provide a destination location 166. In some embodiments, the vehicle control system 126 can transmit the inputted destination location 166 and/or a current location of the vehicle 120 (e.g., as a GPS data packet) as a communication 180 to the server 130 via the communication system 124 and the communications array 122. The server 130 (e.g., the navigation unit 140) can use the current location of the vehicle 120 and/or the inputted destination location 166 to perform an optimization operation to determine an optimal route for the vehicle 120 to travel to the destination location 166. Route data 163 that includes the optimal route can be transmitted from the server 130 to the vehicle control system 126 via the communications array 122 and the communication system 124. As a result of receiving the route data 163, the vehicle control system 126 can cause the operative systems 127 to maneuver the vehicle 120 through traffic to the destination location 166 along the optimal route, assist a driver in maneuvering the vehicle 120 through traffic to the destination location 166 along the optimal route, and/or cause the interior interface system 125 to display and/or present instructions for maneuvering the vehicle 120 through traffic to the destination location 166 along the optimal route.

Alternatively or in addition, the route data 163 includes the optimal route and the vehicle control system 126 automatically inputs the route data 163 into the mapping engine 128. The mapping engine 128 can generate map data 165 using the optimal route (e.g., generate a map showing the optimal route and/or instructions for taking the optimal route) and provide the map data 165 to the interior interface system 125 (e.g., via the vehicle control system 126) for display. The map data 165 may include information derived from the map data 154 stored in the data store 150 on the server 130. The displayed map data 165 can indicate an estimated time of arrival and/or show the progress of the vehicle 120 along the optimal route. The displayed map data 165 can also include indicators, such as reroute commands, emergency notifications, road work information, real-time traffic data, current weather conditions, information regarding laws and regulations (e.g., speed limits, whether right turns on red lights are permitted or prohibited, where U-turns are permitted or prohibited, permitted direction of travel, etc.), news events, and/or the like.

The user input 169 can also be a request to access a network (e.g., the network 110). In response to such a request, the interior interface system 125 can generate an access request 168, which can be processed by the communication system 124 to configure the communications array 122 to transmit and/or receive data corresponding to a user's interaction with the interior interface system 125 and/or with a user device 102 in communication with the interior interface system 125 (e.g., a user device 102 connected to the interior interface system 125 via a wireless connection). For example, the vehicle 120 can include on-board Wi-Fi, which the passenger(s) and/or driver can access to send and/or receive emails and/or text messages, stream audio and/or video content, browse content pages (e.g., network pages, web pages, etc.), and/or access applications that use network access. Based on user interactions, the interior interface system 125 can receive content 167 via the network 110, the communications array 122, and/or the communication system 124. The communication system 124 can dynamically manage network access to avoid or minimize disruption of the transmission of the content 167.

The sensor array 121 can include any number of one or more types of sensors, such as a satellite-radio navigation system (e.g., GPS), a LiDAR sensor, a landscape sensor (e.g., a radar sensor), an IMU, a camera (e.g., an infrared camera, a visible light camera, stereo cameras, etc.), a Wi-Fi detection system, a cellular communication system, an inter-vehicle communication system, a road sensor communication system, feature sensors, proximity sensors (e.g., infrared, electromagnetic, photoelectric, etc.), distance sensors, depth sensors, and/or the like. The satellite-radio navigation system may compute the current position (e.g., within a range of 1-10 meters) of the vehicle 120 based on an analysis of signals received from a constellation of satellites.

The LiDAR sensor, the radar sensor, and/or any other similar types of sensors can be used to detect the vehicle 120 surroundings while the vehicle 120 is in motion or about to begin motion. For example, the LiDAR sensor may be used to bounce multiple laser beams off approaching objects to assess their distance and to provide accurate 3D information on the surrounding environment. The data obtained from the LiDAR sensor may be used in performing object identification, motion vector determination, collision prediction, and/or in implementing accident avoidance processes. Optionally, the LiDAR sensor may provide a 360° view using a rotating, scanning mirror assembly. The LiDAR sensor may optionally be mounted on a roof of the vehicle 120.

The IMU may include X, Y, Z oriented gyroscopes and/or accelerometers. The IMU provides data on the rotational and linear motion of the vehicle 120, which may be used to calculate the motion and position of the vehicle 120.

Cameras may be used to capture visual images of the environment surrounding the vehicle 120. Depending on the configuration and number of cameras, the cameras may provide a 360° view around the vehicle 120. The images from the cameras may be used to read road markings (e.g., lane markings), read street signs, detect objects, and/or the like.

The Wi-Fi detection system and/or the cellular communication system may be used to perform triangulation with respect to Wi-Fi hot spots or cell towers respectively, to determine the position of the vehicle 120 (optionally in conjunction with then satellite-radio navigation system).

The inter-vehicle communication system (which may include the Wi-Fi detection system, the cellular communication system, and/or the communications array 122) may be used to receive and/or transmit data to the other vehicles 170A-N, such as current speed and/or location coordinates of the vehicle 120, time and/or location coordinates corresponding to when deceleration is planned and the planned rate of deceleration, time and/or location coordinates when a stop operation is planned, time and/or location coordinates when a lane change is planned and direction of lane change, time and/or location coordinates when a turn operation is planned, time and/or location coordinates when a parking operation is planned, and/or the like.

The road sensor communication system (which may include the Wi-Fi detection system and/or the cellular communication system) may be used to read information from road sensors (e.g., indicating the traffic speed and/or traffic congestion) and/or traffic control devices (e.g., traffic signals).

When a user requests transportation (e.g., via the application running on the user device 102), the user may specify a specific destination location. The origination location may be the current location of the vehicle 120, which may be determined using the satellite-radio navigation system installed in the vehicle (e.g., GPS, Galileo, BeiDou/COMPASS, DORIS, GLONASS, and/or other satellite-radio navigation system), a Wi-Fi positioning System, cell tower triangulation, and/or the like. Optionally, the origination location may be specified by the user via a user interface provided by the vehicle 120 (e.g., the interior interface system 125) or via the user device 102 running the application. Optionally, the origination location may be automatically determined from location information obtained from the user device 102. In addition to the origination location and destination location, one or more waypoints may be specified, enabling multiple destination locations.

Raw sensor data 161 from the sensor array 121 can be processed by the on-board data processing system 123. The processed data 162 can then be sent by the data processing system 123 to the vehicle control system 126, and optionally sent to the server 130 via the communication system 124 and the communications array 122.

The data store 129 can store map data (e.g., the map data 154) and/or a subset of the map data 154 (e.g., a portion of the map data 154 corresponding to a general region in which the vehicle 120 is currently located). In some embodiments, the vehicle 120 can use the sensor array 121 to record updated map data along traveled routes, and transmit the updated map data to the server 130 via the communication system 124 and the communications array 122. The server 130 can then transmit the updated map data to one or more of the vehicles 170A-N and/or further process the updated map data.

The data processing system 123 can provide continuous or near continuous processed data 162 to the vehicle control system 126 to respond to point-to-point activity in the surroundings of the vehicle 120. The processed data 162 can comprise comparisons between the raw sensor data 161—which represents an operational environment of the vehicle 120, and which is continuously collected by the sensor array 121—and the map data stored in the data store 129. In an example, the data processing system 123 is programmed with machine learning or other artificial intelligence capabilities to enable the vehicle 120 to identify and respond to conditions, events, and/or potential hazards. In variations, the data processing system 123 can continuously or nearly continuously compare raw sensor data 161 to stored map data in order to perform a localization to continuously or nearly continuously determine a location and/or orientation of the vehicle 120. Localization of the vehicle 120 may allow the vehicle 120 to become aware of an instant location and/or orientation of the vehicle 120 in comparison to the stored map data in order to maneuver the vehicle 120 on surface streets through traffic and/or assist a driver in maneuvering the vehicle 120 on surface streets through traffic and identify and respond to potential hazards (e.g., pedestrians) or local conditions, such as weather or traffic conditions.

Furthermore, localization can enable the vehicle 120 to tune or beam steer the communications array 122 to maximize a communication link quality and/or to minimize interference with other communications from other vehicles 170A-N. For example, the communication system 124 can beam steer a radiation patterns of the communications array 122 in response to network configuration commands received from the server 130. The data store 129 may store current network resource map data that identifies network base stations and/or other network sources that provide network connectivity. The network resource map data may indicate locations of base stations and/or available network types (e.g., 3G, 4G, LTE, Wi-Fi, etc.) within a region in which the vehicle 120 is located.

While FIG. 1B describes certain operations as being performed by the vehicle 120 or the server 130, this is not meant to be limiting. The operations performed by the vehicle 120 and the server 130 as described herein can be performed by either entity. For example, certain operations normally performed by the server 130 (e.g., transmitting updating map data to the vehicles 170A-N) may be performed by the vehicle 120 for load balancing purposes (e.g., to reduce the processing load of the server 130, to take advantage of spare processing capacity on the vehicle 120, etc.).

Furthermore, any of the vehicles 170A-N may include some or all of the components of the vehicle 120 described herein. For example, a vehicle 170A-N can include a communications array 122 to communicate with the vehicle 120 and/or the server 130.

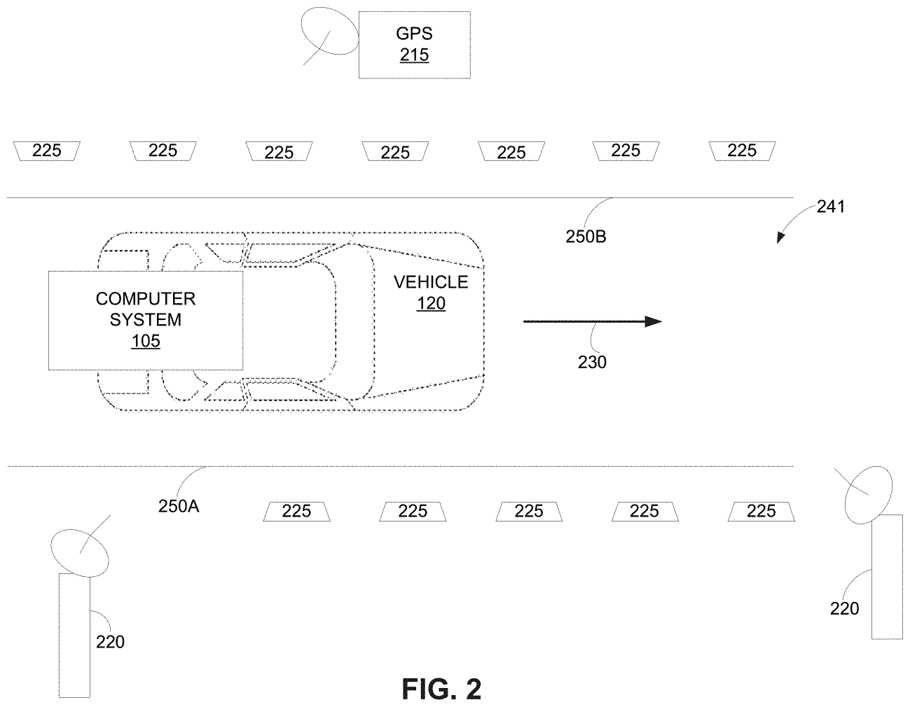

FIG. 2 is a schematic illustrating a vehicle moving along a road and examples of components that the vehicle may use to determine its geographical location information. In various embodiments of the invention, one or more of the described components, or one or more other components, may be used to determine the vehicle's location. In particular, FIG. 2 illustrates an example a vehicle 120 moving along a road 241. The road 241 may be part of the route from the first point to a second point that the vehicle 120 is controlled to manually, semi-autonomously (e.g., by assisting a driver), and/or autonomously traverse. In FIG. 2, vehicle 120 is moving along the road 241 at a speed and in a direction indicated by motion vector 230. FIG. 2 also illustrates examples of positioning components that may be used by the vehicle 120, or provide to the vehicle 120, either passively or actively, geographical location information that the vehicle 120 may use to determine the location (e.g., a geographic location) of the vehicle 120.

As the vehicle 120 moves along the road 241, positioning components that are along the road 241 or in communication with sensors on the vehicle 120 may be used to help control and/or position the vehicle 120. FIG. 2 illustrates a few examples of such positioning components, and examples of sensing systems that may be used for positioning and controlling the vehicle are described herein. In one example, proximal positioning components 250A, 250B may run along the road 241. In various embodiments, such components may be contiguous or closely arranged, and may either be passive (sensed by a sensor on the vehicle 120, e.g., be reflective of a transmitting sensor on the vehicle 120, or be sensed by an IR or optical sensor), or active (e.g., transmit radiation sensed by the vehicle 120). One or more distal positioning components 225 may be arranged beside the road or off the road as certain distance. The distal positioning components 225 may also be active or passive, and various embodiments. In some embodiments, a GPS transmitter 215 may provide GPS signals that are received by the vehicle 120. In some embodiments, one or more fixed transmitters 220 may be disposed along the road 241, and provide the vehicle 120 with transmissions or communications that can be used by vehicle 120 to determine its location.

In various embodiments, the vehicle 120 may include a sensor system as part of a computer system 105, or may include a sensor system on the vehicle that interfaces with the computer system 105. The computer system 105 may include any of the components of the vehicle 120 described above with respect to FIG. 1B. In various embodiments, the sensor system may include one or more sensors configured to sense information about an environment, including positioning components, in which the vehicle 120 is located. In various embodiments, the one or more sensors may include, one or more of a Global Positioning System (GPS) module, an inertial measurement unit (IMU), a radio detection and ranging (RADAR) unit, a laser rangefinder and/or light detection and ranging (LiDAR) unit, an infrared (IR) camera, and/or an optical camera. The GPS module may be any sensor configured to estimate a geographic location of the vehicle 120. To this end, the GPS module may include a transceiver configured to estimate a position of the automobile 100 with respect to the Earth, based on satellite-based positioning data. In an example, the computer system 105 may be configured to use the GPS module in combination with the map data to estimate a location of a lane boundary on road on which the vehicle 120 may be travelling on.

The IMU may be any combination of sensors configured to sense position and orientation changes of the vehicle 120 based on inertial acceleration. In some examples, the combination of sensors may include, for example, accelerometers and gyroscopes. Other combinations of sensors are possible as well.

The RADAR unit may be considered as an object detection system that may be configured to use radio waves to determine characteristics of the object such as range, altitude, direction, or speed of the object. The RADAR unit may be configured to transmit pulses of radio waves or microwaves that may bounce off any object in a path of the waves. The object may return a part of energy of the waves to a receiver (e.g., dish or antenna), which may be part of the RADAR unit as well. The RADAR unit also may be configured to perform digital signal processing of received signals (bouncing off the object) and may be configured to identify the object.

Other systems similar to RADAR have been used in other parts of the electromagnetic spectrum. One example is LiDAR (light detection and ranging), which may be configured to use visible light from lasers rather than radio waves.

The LiDAR unit may include a sensor configured to sense or detect objects in an environment in which the vehicle 120 is located using light. Generally, LiDAR is an optical remote sensing technology that can measure distance to, or other properties of, a target by illuminating the target with light. As an example, the LiDAR unit may include a laser source and/or laser scanner configured to emit laser pulses and a detector configured to receive reflections of the laser pulses. For example, the LiDAR unit may include a laser range finder reflected by a rotating mirror, and the laser is scanned around a scene being digitized, in one or two dimensions, gathering distance measurements at specified angle intervals. In examples, the LiDAR unit may include components such as light (e.g., laser) source, scanner and optics, photo-detector and receiver electronics, and position and navigation system.

In an example, The LiDAR unit may be configured to use ultraviolet (UV), visible, or infrared light to image objects and can be used with a wide range of targets, including non-metallic objects. In one example, a narrow laser beam can be used to map physical features of an object with high resolution.

In examples, wavelengths in a range from about 10 micrometers (infrared) to about 250 nm (UV) could be used. Typically light is reflected via backscattering. Different types of scattering are used for different LiDAR applications, such as Rayleigh scattering, Mie scattering and Raman scattering, as well as fluorescence. Based on different kinds of backscattering, LiDAR can be accordingly called Rayleigh LiDAR, Mie LiDAR, Raman LiDAR and Na/Fe/K Fluorescence LiDAR, as examples. Suitable combinations of wavelengths can allow for remote mapping of objects by looking for wavelength-dependent changes in intensity of reflected signals, for example.

Three-dimensional (3D) imaging can be achieved using both scanning and non-scanning LiDAR systems. “3D gated viewing laser radar” is an example of a non-scanning laser ranging system that applies a pulsed laser and a fast gated camera. Imaging LiDAR can also be performed using an array of high speed detectors and a modulation sensitive detectors array typically built on single chips using CMOS (complementary metal-oxide-semiconductor) and hybrid CMOS/CCD (charge-coupled device) fabrication techniques. In these devices, each pixel may be processed locally by demodulation or gating at high speed such that the array can be processed to represent an image from a camera. Using this technique, many thousands of pixels may be acquired simultaneously to create a 3D point cloud representing an object or scene being detected by the LiDAR unit.

A point cloud may include a set of vertices in a 3D coordinate system. These vertices may be defined by X, Y, and Z coordinates, for example, and may represent an external surface of an object. The LiDAR unit may be configured to create the point cloud by measuring a large number of points on the surface of the object, and may output the point cloud as a data file. As the result of a 3D scanning process of the object by the LiDAR unit, the point cloud can be used to identify and visualize the object. In one example, the point cloud can be directly rendered to visualize the object. In another example, the point cloud may be converted to polygon or triangle mesh models through a process that may be referred to as surface reconstruction. Example techniques for converting a point cloud to a 3D surface may include Delaunay triangulation, alpha shapes, and ball pivoting. These techniques include building a network of triangles over existing vertices of the point cloud. Other example techniques may include converting the point cloud into a volumetric distance field and reconstructing an implicit surface so defined through a marching cubes algorithm.

The camera may be any camera (e.g., a still camera, a video camera, etc.) configured to capture images of the environment in which the vehicle 120 is located. To this end, the camera may be configured to detect visible light, or may be configured to detect light from other portions of the spectrum, such as infrared or ultraviolet light. Other types of cameras are possible as well. The camera may be a two-dimensional detector, or may have a three-dimensional spatial range. In some examples, the camera may be, for example, a range detector configured to generate a two-dimensional image indicating a distance from the camera to a number of points in the environment. To this end, the camera may use one or more range detecting techniques. For example, the camera may be configured to use a structured light technique in which the vehicle 120 illuminates an object in the environment with a predetermined light pattern, such as a grid or checkerboard pattern and uses the camera to detect a reflection of the predetermined light pattern off the object. Based on distortions in the reflected light pattern, the vehicle 120 may be configured to determine the distance to the points on the object. The predetermined light pattern may comprise infrared light, or light of another wavelength. The sensor system may additionally or alternatively include components other than those described here.

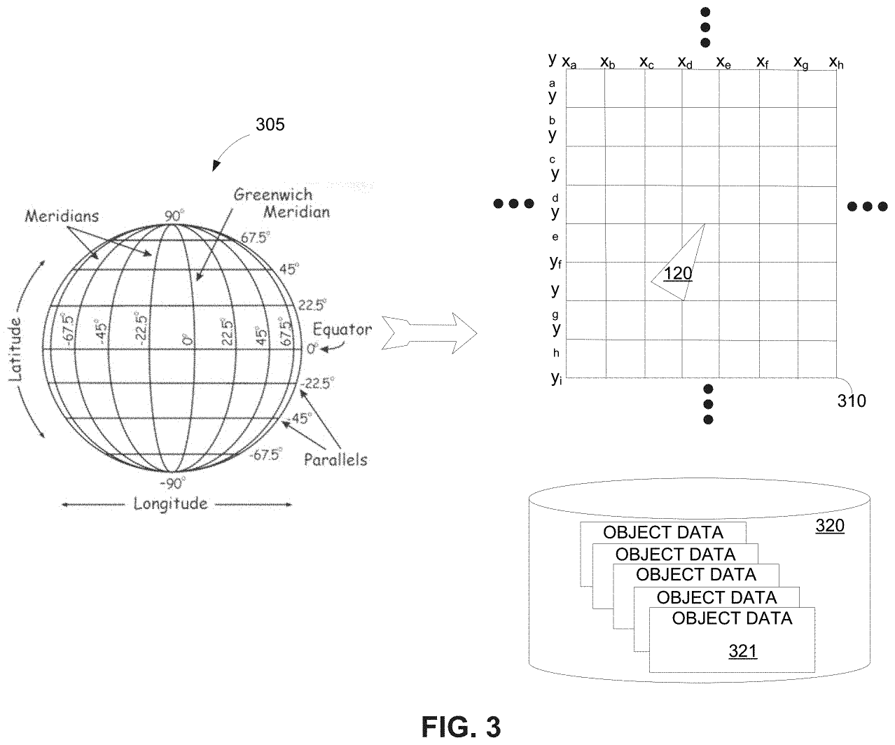

FIG. 3 is a schematic illustrating an example of map data that may be represented by a plurality of map data tiles 310. In various embodiments, the stored information may represent two-dimensional data or three-dimensional data. In various embodiments, such map data may include information relating to natural or man-made features (objects). In some examples, map data may include object geometry data from which the shape, size and location of an object may be determined. For example, map data may include one or more of elevation data of natural or man-made features, intensity data (e.g., images), and/or object information (e.g., location information of an object, points of an object, edges of an object, surfaces of an object, area of an object, minimum bounding rectangle of an object, etc.). In various embodiments and depending on the implementation, map data may be stored in file format, in a database, or in any other suitable format that may be quickly accessed from, for example, a storage component configured to store large amounts of data (e.g., terabytes or more).

Map data may be represented in a number of ways. As illustrated in FIG. 3, locations on the earth 305 may be referenced by lines of latitude and lines of longitude. For a particular location on earth of a vehicle 120, the latitude and longitude information may be represented by a plurality of map data tiles 310 arranged in a grid around the vehicle 120. Due to the latitude/longitude reference system and the shape of the earth, geographic distances between incremental lines of latitudes are consistent. However, geographic distances between incremental lines of longitude depend on the location on the earth, being closer together at the poles. Accordingly, grid patterns of map data representing a portion of earth that are designated in reference to longitudes and latitudes (as many typically are) may not be exactly rectangular, and they will be less rectangular closer to the poles. For the purpose of this disclosure, map data tiles 310 that depict map data representing a portion of the earth, or objects located relative to a position on the earth, will be assumed to be rectangular, or substantially rectangular, due in part to the relatively small size of the map data tiles 310. The map data referred to herein does not necessarily need to be referenced in terms of longitude and latitude. Instead other coordinate reference systems may be used.

As illustrated in FIG. 3, in some embodiments map data may be stored either in a ordered file arrangement, as illustrated by the map data tiles 310. In other embodiments, FIG. 3 illustrates that map data may be stored in a database 320, for example, as a plurality of object records 321. In some embodiments, the object records 321 are entries in one or more databases, and may include any of the type of information discussed above in reference to map data. The information stored in database 320 may be retrieved based on a designated point or location (e.g., the location of the vehicle). For example, objects stored in database 320 that meet certain distance criteria and/or location criteria relative to the direction the vehicle is heading, may be retrieved. In some examples, only information relating to objects that are within a certain distance of the vehicle are retrieved. In some embodiments, only information that is a certain distance away from the vehicle and within a certain distance (e.g., between a minimum distance and a maximum distance) are retrieved. In some embodiments, the objects retrieved are at a certain orientation relative to the vehicle (for example, in front of the vehicle, to the sides of the vehicle, behind the vehicle, above the vehicle). The data (objects) retrieved from the database 320 that is near the vehicle location is sometimes referred to herein as a proximal portion of the stored data (e.g., object geometry data).

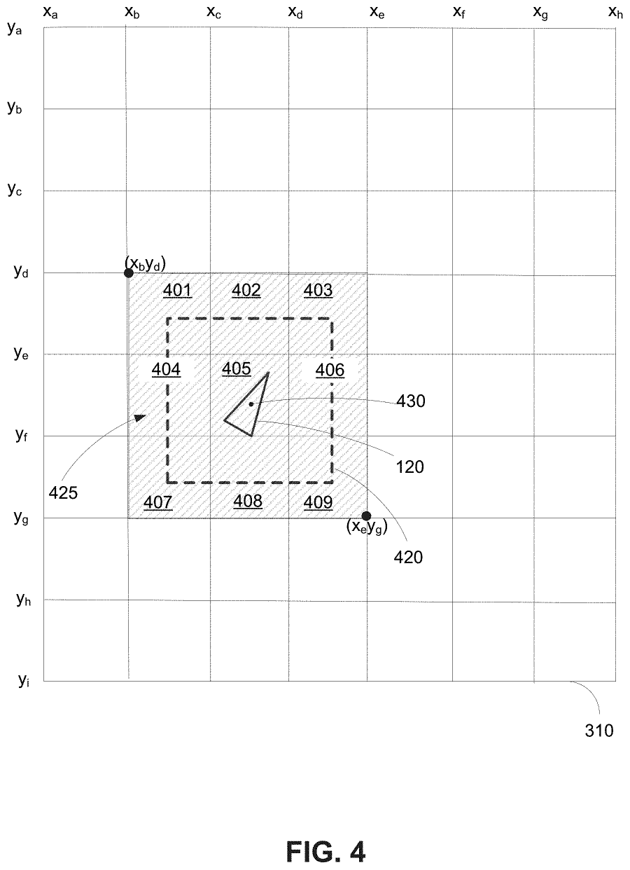

FIG. 4 is a schematic illustrating an example of HD map data that may be loaded into memory based on a vehicle's initial (or first) geographic location, for example, by loading the data including a plurality of data tiles or by a determined distance around the vehicle, according to some embodiments. FIG. 4 shows vehicle 120 located at a first geographic location 430. In this example, a boundary 420 is a representation of the distance from the vehicle 120 to retrieve information of objects. The boundary 420 may be determined by the computer system 105 based on a number of criteria, predetermined and/or dynamic (e.g., speed of the vehicle). The object information may be stored, for example, in map data tiles 401-409. If the object information is stored in map data tiles, a minimum bounding rectangle (x_{b}y_{d}, xₑy_{g}) may be used to retrieve the desired map data tiles 401-409.

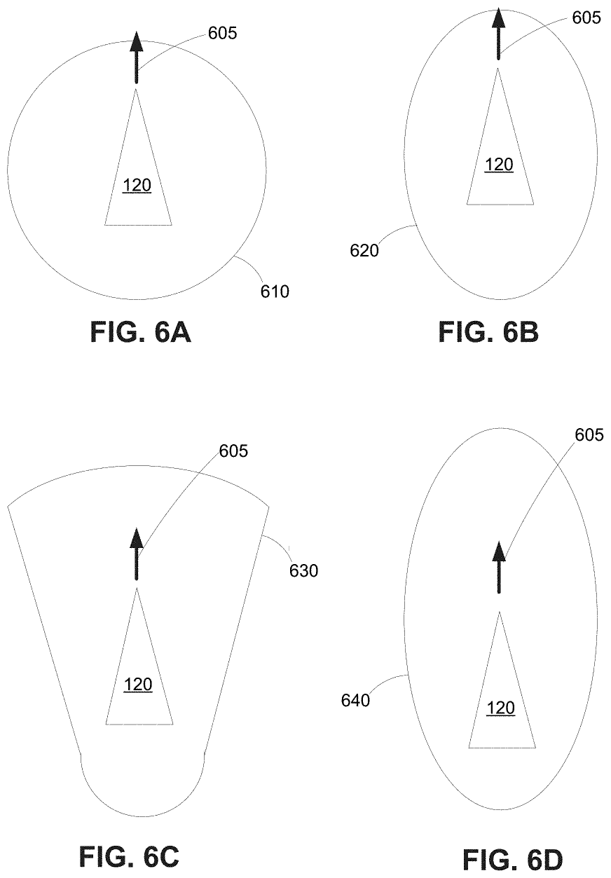

FIG. 4 also illustrates one advantage of retrieving information from a database based on a certain area around the vehicle. In some embodiments, the shape and/or the dimensions of the area in which data is retrieved can be predetermined, determined from a selection of predetermined shapes and/or sizes based on at least one criteria (e.g., speed of the vehicle), or can be dynamically determined based on at least one criteria (speed, type of road, geographic location, and the like). Retrieving information from a database of a particular area around the vehicle loads into memory only information within an area boundary, instead of the all information in the areas 401-409 including the information that is outside of the boundary, and thus may be more efficient as the information loaded may be just the data that is needed and not extra data. In this example, the boundary 420 is a square centered on the vehicle 120. In other embodiments, the boundary may be off-centered from the vehicle and/or of different shapes, as illustrated in FIGS. 6A-6D. In some embodiments, the boundary shape is symmetric with respect to the road the vehicle is traveling.

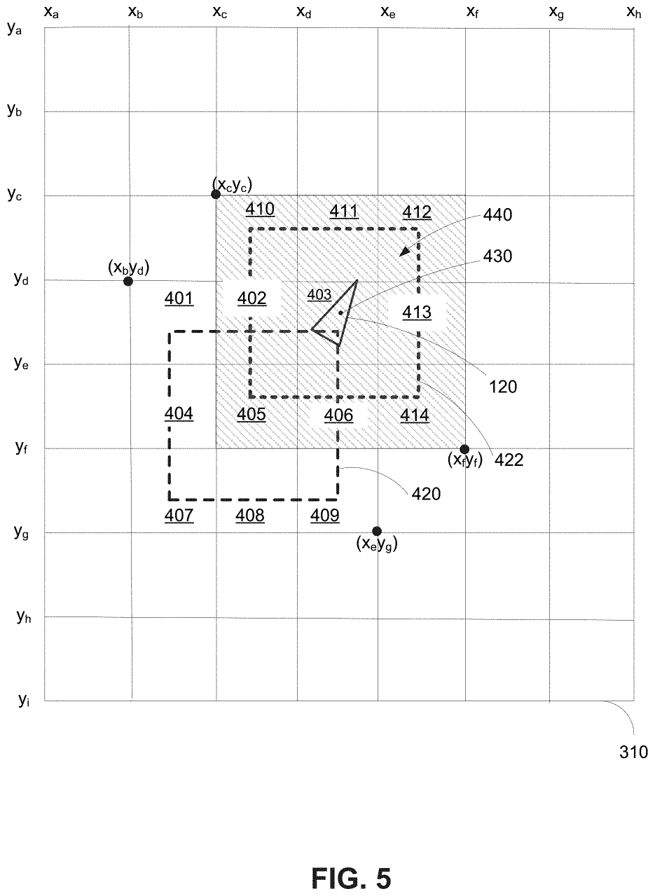

FIG. 5 is a schematic illustrating an example of data (e.g., HD map data) that may be loaded into memory based on a vehicle updated (or second) geographic location, for example, by loading the data including a plurality of data tiles or by a determined distance around the vehicle. In FIG. 5, the vehicle 120 is now located at an updated geographic position 430, and in updated boundary 422 representing a certain minimum distance around the vehicle 120 to retrieve information. “Proximal portion” as used herein refers to a portion of the stored data that has been retrieved to provide information of objects around or near a vehicle location. In FIG. 5, the proximal portion 440 represents retrieved information (e.g., from a database) that at least partially surrounds the updated location 430 of the vehicle 120, and in this implementation completely surrounds the location 430 of the vehicle 120. As the vehicle 120 travels along a route, numerous proximal portions of stored data are retrieved from the (large capacity) storage component and stored into a memory component that a processor may quickly access to position and otherwise control aspects of the vehicle.

FIGS. 6A-6D illustrate examples of portions of stored geometry data (i.e., proximal portions) that may be retrieved from a large geometry data storage component and stored into a memory component (e.g., working memory) for a vehicle. The direction of the vehicle's 120 in FIGS. 6A-6D is represented by arrows 605. The retrieved geometry data represents a proximal portion (proximal to the vehicle/vehicle location) of the stored geometry data. Each of FIGS. 6A-6D illustrate an example of a proximal portion of geometry data as being identified by a representative retrieval area boundary, according to various embodiments. The shape, symmetry, orientation, and dimensions of the retrieval area boundary may be different in various embodiments. Similarly, the proximal portion of geometry data that is retrieved from the storage component based on the retrieval area boundary may also vary in shape, symmetry, orientation, and dimensions in various embodiments. In some implementations, although the proximal portion of geometry data that is desired to be retrieved may correspond to a certain retrieval area boundary, to actually retrieve the geometry data from a database, one or more minimum bounding rectangles (MBR), two-dimensional or three-dimensional, are used to retrieve all of the geometry data within the retrieval area boundary resulting in additional geometry data being retrieved and stored in memory. In such implementations, the less the retrieval area boundary corresponds to one or more MBR's, the more additional geometry data may be retrieved.

FIG. 6A illustrates one example of a circular-shaped retrieval boundary 610 centered on the vehicle 120, such that the proximal portion of geometry data retrieved surrounds the vehicle 120 out to an equal distance from the vehicle. FIG. 6B illustrates one example of an elliptical-shaped retrieval boundary 620 centered on the vehicle 120, Such that the proximal portion of geometry data retrieved surrounds the vehicle 120, and extends farther in front of the vehicle and behind the vehicle than it does to the sides of the vehicle 120. FIG. 6C illustrates one example of a retrieval boundary 630 that is larger in front of the vehicle 120 than on the sides of the vehicle 120 and behind the vehicle. The portion of the boundary 630 in front of the vehicle is fan shaped, extending along the curve on either side of the vehicle. The portion of the boundary 630 in back of the vehicle 120 is not a stand away from the vehicle as far as the portion of boundary 630 in front of the vehicle. Such a configuration of a retrieval boundary may be advantageous to reduce the amount of data retrieved as the speed of the vehicle increases, or if the vehicle is traveling on a remote road, for example, where there are few, if any, roads that intersect the road the vehicle was traveling on. FIG. 6D illustrates an elliptical-shaped retrieval boundary 640 offset relative to the vehicle 120 such that it extends further in front of the vehicle than in the back of the vehicle. The retrieval boundary 640 may also be advantageous in areas that are relatively remote and/or situations where it is determined that objects behind the vehicle into the sides of the vehicle are less likely to be needed to control (e.g., position) the vehicle. In some embodiments, when the vehicle is traveling along a route determined by a navigation system, the navigation system may provide information that may be used to determine the proximal portion of data to be retrieved. In some embodiments, the proximal portion of data to be retrieved, as identified by retrieval boundary, changes dynamically based on predetermined information or information that the vehicle senses.

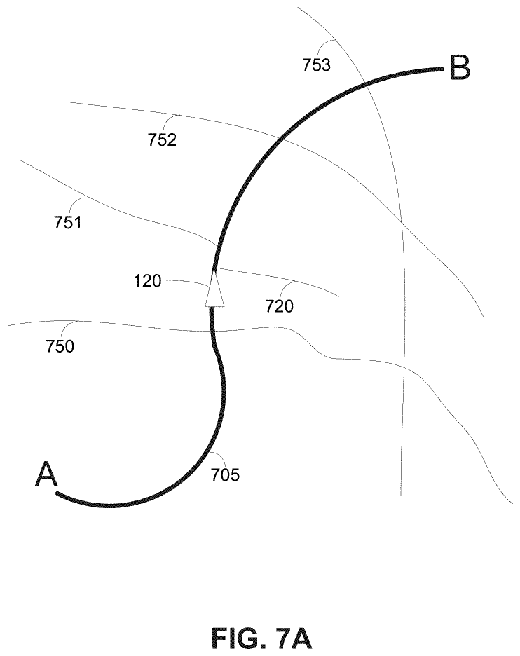

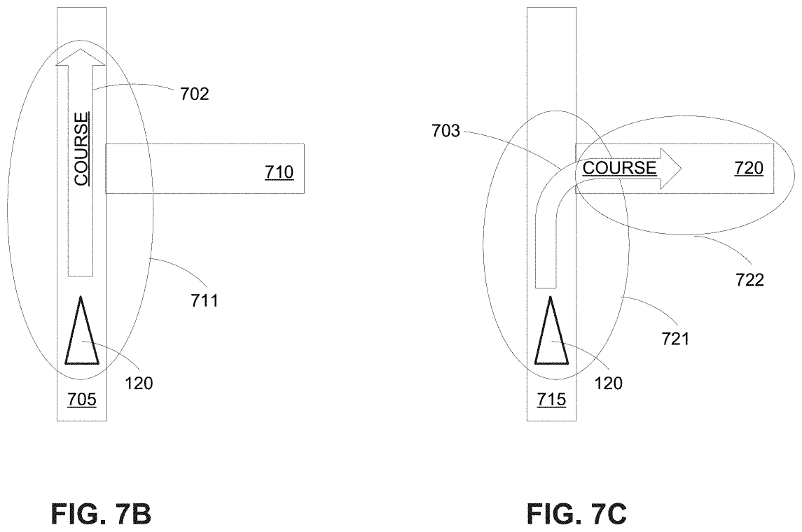

FIGS. 7A-C illustrate examples of a vehicle 120 (e.g., an autonomous vehicle) traveling on a road along a route and other roads along the route that intersect the road the vehicle is traveling along, and how knowledge of the route of the vehicle can be used to facilitate loading the correct geometry data when the vehicle is approaching or is at an intersection of two or more roads. In FIG. 7A, vehicle 120 is traveling along a route 705 from point A to point B. Route (road) 705 may have been determined by navigation system, and as the vehicle 120 moves along the route 705, its position on the road and its location (e.g., geographic location) may be determined by one or more sensor systems, for example, any of the sensor systems described herein. In some instances, a route that the vehicle is traveling on may be relatively remote such that it has few intersecting roads. In FIG. 7A, numerous roads 720, 750, 751, 752, 753 intersect the route 705. Any time the vehicle 120 is at an intersection formed by one of the roads 720, 750, 751, 752, 753 and the route 705, some information determined by the vehicle relating to the location and/or positioning of the vehicle may ambiguously indicate the vehicle is on a different road rather than route 705, which may affect geometry data being loaded for the vehicle.

FIG. 7B is a schematic illustrating an embodiment of a vehicle traveling along a route and geometry data being retrieved by the vehicle. Here, vehicle 120 is traveling along route 705 and is approaching an intersection with road 710. In this case, the planned course 702 of the vehicle is to continue past road 710. As the vehicle 120 moves along route 705, geometry data of the environment around the vehicle and a defined area 711 is being loaded from a storage device, capable of storing large amounts of geometry data, into a memory component configured to hold a limited amount of geometry data but to allow faster access of the geometry data such that it is quickly accessible for processing. In this example, the defined area 711 is an area that surrounds the vehicle 120, that has a center of the defined area 120 offset from the location of the vehicle 120 and extending further in front of the vehicle (along the expected course 702) than behind the vehicle or to the sides of the vehicle. Because the course 702 of the vehicle is known to extend past the road 710, the defined area 711 also extends pass the road 710 in the direction of the course 702.

FIG. 7C is a schematic illustrating another example of the vehicle 120 traveling along another route 715. In this example, the course 703 of the vehicle turns into road 720. Because the course 703 of the vehicle 120 is known to extend into road 720 (e.g., due to information from a navigation system), a first area 721 may be defined to load geometry data for the vehicle that is traveling along the route 715 and a second area 722 is defined to load geometry data for the vehicle 120 when it is traveling along the road 720.

The techniques described herein may be implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

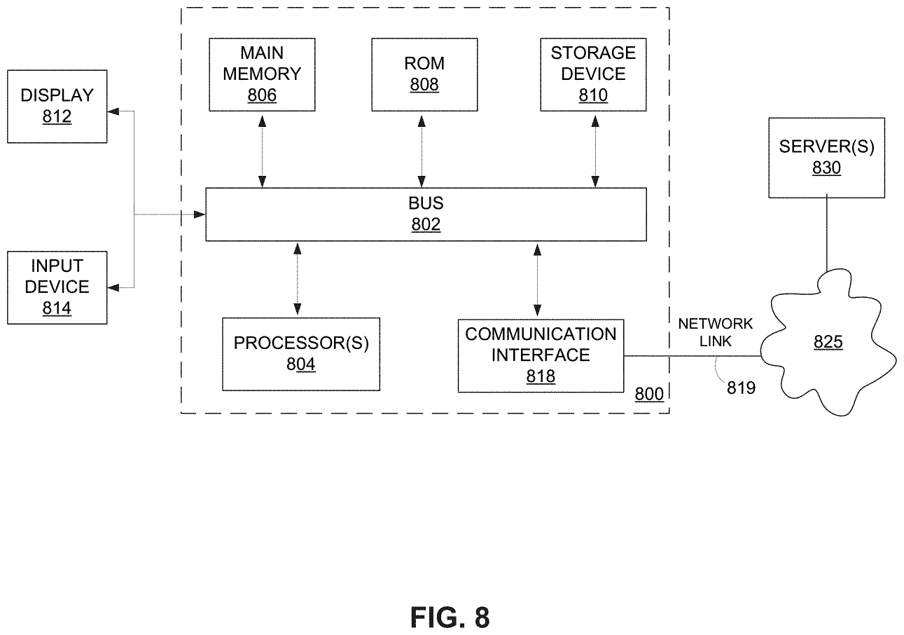

FIG. 8 is a block diagram that illustrates a computer system 800 upon which any of the embodiments described herein may be implemented, for example, computer system 105 illustrated in FIG. 1. The system 800 may correspond identically to the system 105 described above, or have one or more different components. The computer system 800 includes a bus 802 or other communication mechanism for communicating information, and one or more hardware processors 804 coupled to the bus 802 for processing information. Hardware processor(s) 804 may be, for example, one or more general purpose microprocessors. The processor(s) 804 may correspond to a processor described above in reference to computer system 105.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions. In some embodiments, the instructions may cause the computer system 800 to obtain a location of the vehicle, determine data retrieval information based on the vehicle location, the data retrieval information identifying a proximal portion of stored object geometry data that is within a certain distance of the vehicle. The instructions may also cause the computer system 800 retrieve the proximal portion of the object geometry data from a data storage device 810 and store the proximal portion of the object geometry data in the main memory 806. In some embodiments, the instructions may also cause the computer system 800 to determine a route of one or more roads for the vehicle to travel along from a location the vehicle to a destination, obtaining road identification indicative of a road the vehicle is on while the vehicle is traveling along the route, and determining the data retrieval information based on the vehicle location and the road identification information.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions. The main memory 806, the ROM 808, and/or the storage 810 may correspond to the memory 106 described above for storing map data. In some embodiments, the main memory 806 is the memory used to store the map data tiles when they are being used to control the vehicle 120. For example, one or more map data tiles may be initially stored on the storage device 810 and then, as needed based on the methods and systems described herein, the one or more map data tiles may be loaded into memory 806 and used to control the vehicle 120.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The main memory 806, the ROM 808, and/or the storage 810 may include non-transitory storage media. The term “non-transitory media,” and similar terms, as used herein refers to a media that store data and/or instructions that cause a machine to operate in a specific fashion, where the media excludes transitory signals. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 800 also includes a communication interface 818 coupled to bus 802. Communication interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic or optical signals that carry digital data streams representing various types of information.

The computer system 800 can send messages and receive data, including program code, through the network(s) 825, network link 819 and communication interface 818. The networks(s) 825 maybe connected to one or more servers 830. In the Internet example, a server might transmit a requested code for an application program through the Internet, the ISP, the local network and the communication interface 818. The received code may be executed by processor 804 as it is received, and/or stored in storage device 810, or other non-volatile storage for later execution.

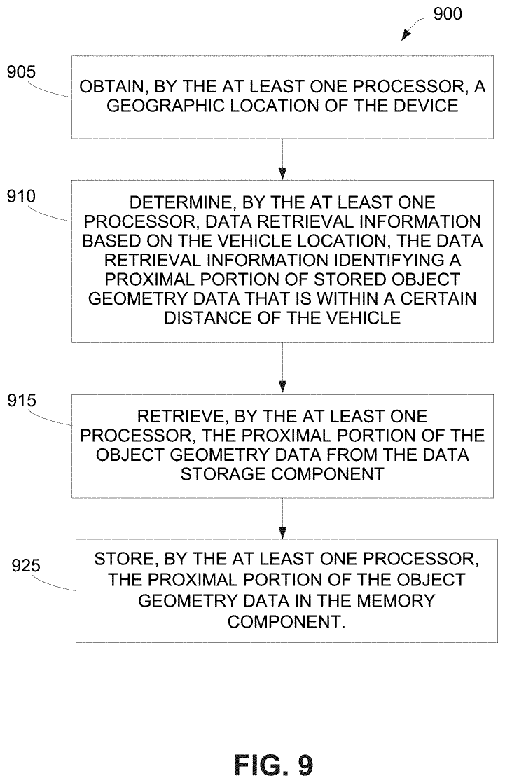

FIG. 9 is an illustration of a flow diagram representing an example of a process 900 of loading object geometry data from a storage component, having a large storage capacity, to a quickly accessible memory component that is coupled to at least one processor. At block 905, the process 900 obtains by the at least one processor a geographic location of the device. In some embodiments, the geographic location of the device may be based on information from any of the sensors described in reference to FIG. 2. At block 910, the process 900 determines by the at least one processor data retrieval information based on the vehicle location. The data retrieval information includes information identifying a proximal portion of stored object geometry data that is within a certain distance of the vehicle. In various embodiments as discussed herein, the data retrieval information may correspond to an area that has a shape or size that is predetermined, or determined at least in part by characteristic of the vehicle, for example, its speed.

At block 915, the process 900 retrieves by the at least one processor the proximal portion of the object geometry data from the data storage component. The data storage component is configured to hold large amounts of data, for example, terabytes (or more) of object geometry data. In the block 925, the process 900 stores by the at least one processor the proximal portion of the object geometry data in the memory component. In various embodiments, a processor may access the object geometry data stored in the memory component faster than it could access the same object geometry data stored in the data storage component, for example, more than two times faster, more than five times faster, more than 10 times faster, or more than 100 times faster. In some embodiments, the data storage component comprises optical or magnetic disk. The memory component may comprise volatile or non-volatile memory cells/circuits on one more chips (e.g., RAM) to store the object geometry data, and such data may be accessed at the same speed regardless of where it stored in the memory.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm or model. In some embodiments, a machine learning algorithm or model may not explicitly program computers to perform a function, but can learn from training data to make a predictions model (a trained machine learning model) that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Headings are included herein for reference and to aid in locating various sections. These headings are not intended to limit the scope of the concepts described with respect thereto. Such concepts may have applicability throughout the entire specification.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures may be combined, interchanged or excluded from other embodiments.

The phrase “based on” does not mean “based only on,” unless expressly specified otherwise. In other words, the phrase “based on” describes both “based only on” and “based at least on.” Unless otherwise explicitly stated, articles such as “a” or “an” should generally be interpreted to include one or more described items. Accordingly, phrases such as “a device configured to” are intended to include one or more recited devices.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims. Applicant reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for loading object geometry data, implemented on a device on a vehicle, the device having at least one processor having a memory component and a data storage component coupled to the processor, the method comprising:
obtaining, by the at least one processor, a location of the vehicle;
obtaining an expected course of the vehicle from a navigation system of the vehicle;
determining, by the at least one processor, data retrieval information based on the vehicle location, the data retrieval information identifying a proximal portion of stored object geometry data that is within a certain distance of the vehicle, wherein the proximal portion of the stored object geometry data is represented by a retrieval area boundary that at least partially surrounds the vehicle and that has a shape based on the expected course of the vehicle;
retrieving, by the at least one processor, the proximal portion of the object geometry data from the data storage component; and
storing, by the at least one processor, the proximal portion of the object geometry data in the memory component.

2. The method of claim 1, wherein the data storage component is configured to store the object geometry data in a data structure such that a portion of the stored object geometry data representing an area around the vehicle may be retrieved.

3. The method of claim 1, wherein the vehicle is an autonomous vehicle.

4. (canceled)

5. The method of claim 1, further comprising obtaining by the at least one processor the speed and direction of the vehicle, and wherein determining the data retrieval information comprises determining the based at least in part on the speed and direction of the vehicle.

6. The method of claim 1, further comprising
determining the expected course of one or more roads for the vehicle to travel along from the location of the vehicle to a destination,
obtaining road identification information indicative of a road the vehicle is on while the vehicle is traveling along the expected course; and
determining the data retrieval information based on the vehicle location and the road identification information.

7. The method of claim 6, wherein the road identification information includes information on one or more roads that are along the expected course and that the vehicle is approaching.

8. The method of claim 7, further comprising determining the distance the vehicle has traveled along the expected course, and wherein determining data retrieval information is based in part on the distance the vehicle has traveled along the expected course.

9. A system on a vehicle, comprising:
a data storage component configured to store object geometry data in a data structure such that a portion of the stored object geometry data may be retrieved;
at least one processor having a memory component, wherein the at least one processor is further configured to:
obtain a location of the vehicle;
obtain an expected course of the vehicle;
determine data retrieval information based on the vehicle location, the data retrieval information identifying a proximal portion of the object geometry data that is within a certain distance of the vehicle, wherein the proximal portion of the object geometry data is represented by a retrieval area boundary that at least partially surrounds the vehicle and that has a shape based on the expected course of the vehicle; and
retrieve the proximal portion of the object geometry data from the data storage component and store it in the memory component.

10. (canceled)

11. The system of claim 9, wherein the proximal portion of the object geometry data is centered on the vehicle location.

12. The system of claim 9, wherein the proximal portion of the object geometry data extends farther in distance from the front of the vehicle at the vehicle location than from the back of the vehicle.

13. The system of claim 9, wherein the proximal portion of the object geometry data surrounds the vehicle location.

14. The system of claim 9, further comprising a global positioning system (GPS), and wherein the at least one processor is further configured to obtain the location of the vehicle from the GPS.

15. The system of claim 9, wherein the at least one processor is further configured to obtain the speed and direction of the vehicle, and determine the data retrieval information based at least in part on the speed and direction of the vehicle.

16. The system of claim 9, wherein the at least one processor is further configured to:
obtain road identification information indicative of a road the vehicle is on; and
determine data retrieval information based on the vehicle location and the road identification information.

17. The system of claim 16, further comprising a navigation system configured to receive an input identifying a destination, determine the expected course of one or more roads for the vehicle to travel along from the location of the vehicle to the destination, determine the road identification information while the vehicle is traveling along the expected course, and communicate the road identification information to the at least one processor.

18. The system of claim 17, wherein the at least one processor is further configured to obtain a speed of the vehicle, and wherein the at least one processor is further configured to determine the data retrieval information based in part on the speed of the vehicle.

19. The system of claim 17, further comprising an odometer device configured to determine the distance the vehicle has traveled along the expected course, wherein the data retrieval information is based in part on the distance the vehicle has traveled along the expected course.

20. The system of claim 19, wherein the road identification information includes information on roads that are along the expected course that the vehicle is approaching.
